(19) United States
(12) Patent Application Publication
(10) Pub. No.: US 2024/0152506 A1
(43) Pub. Date: May 9, 2024

(54) BATCH DETECTION AND OPTIMIZATION

(71) Applicant: Microsoft Technology Licensing, LLC, Redmond, WA (US)

(72) Inventors: Mohammadreza FANI SANI, Lyngby (DK); Michal Adam SROKA, Birkerød (DK); Alejandro GUTIERREZ MUNOZ, Parkland, FL (US); Shahab MORADI, San Bruno, CA (US)

(21) Appl. No.: 18/054,121

(22) Filed: Nov. 9, 2022

(51) Int. Cl. G06F 16/23; G06F 11/34

(52) U.S. Cl. CPC G06F 16/2386; G06F 11/3423

(57) ABSTRACT

Solutions for identifying and optimizing batch processes are provided herein. A task monitor identifies a plurality of processes in an event log. The processes identified by the task monitor are used by a batch processing engine to identify batches from the processes. The batch processing engine compares each of the identified batches to a set of policies or with other identified batches. The batch processing engine provides a recommendation to user to optimize a particular batch, for example, based on the comparing. Identifying batches and providing recommendations to optimize the batches enables processes associated with the batches to be optimized upon implementation of the recommendation.

### BACKGROUND

Many business operations involve tasks that are executed by users and/or devices in batch/bulk on a regular basis. These repetitive tasks can be time and/or resource intensive. While users can use various resources, such as computers, to help perform these tasks, sometimes users are be able to identify tasks that can be batched together and optimized, or even how to optimize these batchable tasks. Furthermore, even if a user has the technical savvy to optimize certain tasks, many of those savvy users do not bother to take the time to identify the tasks that can be batched and optimized, nor do they take the time to determine how to optimize these batchable tasks.

### SUMMARY

The disclosed examples are described in detail below with reference to the accompanying drawing figures listed below. The following summary is provided to illustrate some examples disclosed herein. It is not meant, however, to limit all examples to any particular configuration or sequence of operations.

Example solutions for optimizing a batchable process include: identifying a plurality of processes in an event log; rank each of the plurality of processes based at least on a plurality of characteristics; identifying a process from the plurality of processes as a batch when a ranking of the process is above a batch ranking threshold; compare the batch with a set of policies; and based on the comparing, provide a recommendation to optimize the process within the batch.

### BRIEF DESCRIPTION OF THE DRAWINGS

The disclosed examples are described in detail below with reference to the accompanying drawing figures listed below:

FIG. 1 illustrates an example architecture that advantageously provides for optimizing a batchable process;

FIG. 2. illustrates an event log available with various architectures, such as the example architecture of FIG. 1;

FIG. 3 illustrates segmentation of a partitioned plurality to tuples with various architectures, such as the example architecture of FIG. 1;

FIG. 4 illustrates a two-dimensional dotted chart for different process instances in the event log with various architectures, such as the example architecture of FIG. 1;

FIG. 5 illustrates an additional view of a two-dimensional dotted chart for different process instances in the event log with various architectures, such as the example architecture of FIG. 1;

FIG. 6 shows a flowchart illustrating exemplary operations that are performed using examples of various architectures, such as the example architecture of FIG. 1; and

FIG. 7 shows a block diagram of an example computing device suitable for implementing some of the various examples disclosed herein.

Corresponding reference characters indicate corresponding parts throughout the drawings.

### DETAILED DESCRIPTION

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

Tasks that are executed by users in batch/bulk on a regular basis can cause a user to spend as much as an hour in a typical workday performing these repetitive tasks. Users do not have the resources or the capability to identify tasks that can be batched together and optimized, or even how to optimize these batchable tasks. Further, some businesses are unable to efficiently identify batchable tasks executed by their employees or how to optimize the batchable tasks after they are identified. Diagrams have been used that show tasks that were executed over a period time and users/businesses manually go through this information to determine whether a group of tasks are batchable. However, when there are thousands to even millions of tasks to monitor, manually identifying all of the batchable tasks is often impractical. Furthermore, these manual processes do not provide solutions to optimize the batchable tasks.

Solutions for identifying and optimizing batchable processes are provided. A task monitor monitors and collects data from a storage database or an event log. The data within the storage database or the event log includes information about process instances that are stored or organized into fields. The task monitor is able to quickly and efficiently parse through the information and organize each process in to a set of fields that can easily be displayed as an event log or used by a batch engine to determine whether a process is batchable. As explained in further detail below, a process includes a plurality of activities, each comprised of a set of tasks that, that when executed, perform the process. However, a process is determined to be a batchable process when a ranking of characteristics of the process exceed a batch ranking threshold.

Aspects of the disclosure optimize the operation of computing devices, for example, enabling a processor to execute less tasks per activity or executing these tasks more efficiently, thereby reducing electricity consumption (e.g., the processor uses less processing power to execute a given process) as well as using fewer resources to perform the activity and batchable process. This is accomplished, at least in part, identifying a plurality of processes in an event log or database and identifying certain processes as batchable processes. Once the batchable processes are identified, the batchable processes are then analyzed and compared to other batchable processes to determine modifications to batchable process that, when implemented, optimize the batchable process that optimizes the performance of the overall resource costs, waiting time between different stakeholders, and the throughput time for each process instance.

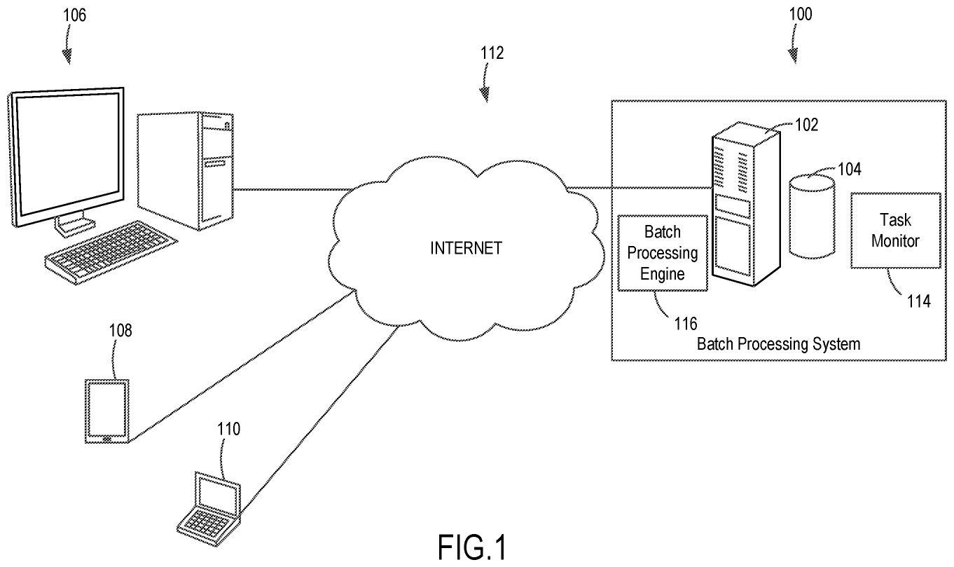

FIG. 1 is an exemplary architecture of a schematic block diagram of a batch processing system 100 deployed as a cloud service in this example. However, the batch processing system 100 can be deployed in non-cloud application, such as at local devices. The batch processing system 100 includes one or more computers 102 and storage 104 to store process information, for example, a process-ID, activity, timestamp, requested credit, resource cost, resource, location, and age of a user in some examples. The batch processing system 100 is connected to a plurality of end user computing devices, such as a desktop computer 106, a smart phone 108 and a laptop computer 110. For example, the batch processing system 100 is shown as connected to the end user computing devices via a computer network 112, illustrated as the Internet.

The batch processing system 100 is configured to operate using a task monitor 114 and a batch processing engine 116. It should be appreciated that some or all of the batch processing system 100 or the functionality of the batch processing system 100 can be implemented in the cloud as well as on the one or more computers 102, or on the end user computing devices (the desktop computer 106, the smart phone 108, and the laptop computer 110).

The task monitor 114 of the batch processing system 100 is configured to track GUI-based tasks as a user manually performs each task on a computing device. The task monitor 114 monitors, pre-processes, and records user's GUI-based tasks as they are executed on a user's computing device. The task monitor 114 operates in the background of an OS on a computing device of the user. Because of this, the user is unaware that the task monitor 114 is monitoring and recording the tasks performed by the user as the user goes about performing various tasks via inputs, such as those from a keyboard and a mouse. IN some example, tracked tasks include inputs from the keyboard, mouse, touchscreen, or other such inputs used for selections of options of GUI-based applications.

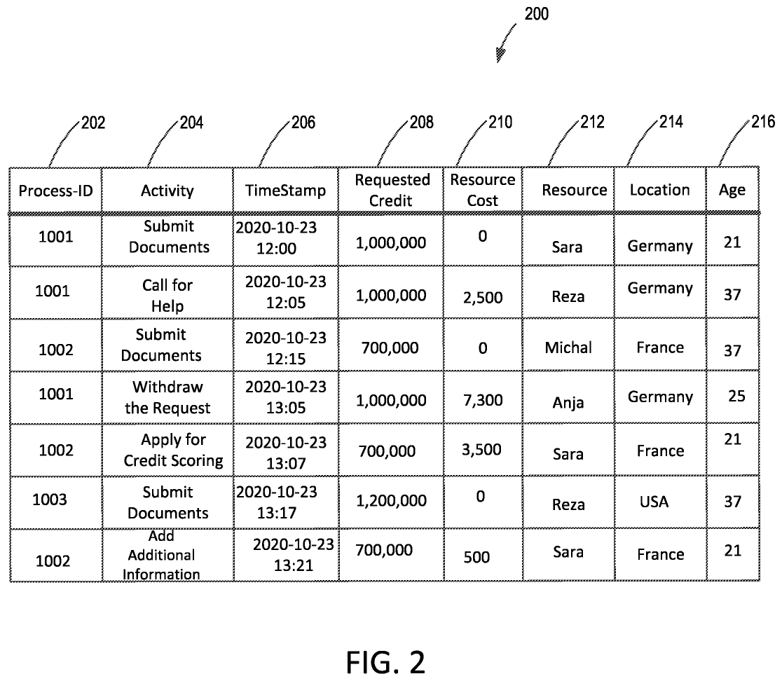

In addition, the task monitor 114 is also configured to monitor tasks and activities, which are a group of tasks, that are input into the storage 104 manually by users or automatically input into the storage 104 through devices equipped with, for example, radio-frequency identification (RFID) and/or Quick Response code (QR) functionality. For example, an RFID/QR tag or asset tag is affixed to an object and contains information pertaining to that object. As it pertains to the tasks described herein, RFID/QR identification employs equipment tags and/or process tags that support specific activities. The computing device such as the smart phone 108 and the laptop computer 110 being Bluetooth-enabled mobile devices, can deposit information onto, and retrieve information from, RFID/QR tags. Using RFID/QR tagging when a task pertaining to that object is performed enables that task to be automatically input into the storage 104. Further, by using RFID/QR tagging, the associated task is automatically associated with a particular user, a process-ID, and a timestamp, and this information is placed into the event log as shown in FIG. 2.

For example, with reference now to FIG. 2, and event log 200 is provided. The event log 200 is an example of how input of a process performed by users is organized and stored within the storage 104. That is, the event log 200 includes a plurality of fields, a process-ID field 202, an activity field 204, a timestamp field 206, a customer credit field 208, a resource field 210, a resource field 212, and an age field 214. In some examples, the event log 200 includes additional fields or less fields than what is provided in the event log 200. In one example, the event log 200 only includes the process-ID field 202, the activity field 204, and the timestamp field 206 or the event log 200 only includes the process-ID field 202, the activity field 204, the timestamp field 206, and the resource field 212. Further, while the event log 200 considers one activity and one resource per process-ID, in some examples, an activity and a resource are higher level, for example, not a specific activity or resource and are represented as a group of activities or resources, such as departments or companies.

The process-ID field 202 represents an ID of a process instance that a resource performs an activity for. A resource is a name of a user performing an activity, and an activity describes an event that was performed/executed by the resource. In one example, an activity is a set of one or more tasks. That is, in one example, an activity is a single task, for example, a mouse click or a user signing in for work using an ID badge. In other examples, an activity is a plurality of tasks performed in a sequence, for example, a user filling out a particular report. As shown in FIG. 2, the activities field 204 include activities that include multiple tasks, such as, submits documents, call for help, withdraw the request, apply for credit scoring, and add additional information. In some examples, the activities are user defined, for example, by an administrator or employer. As such, each activity is already defined prior to the event log 200 being created and prior to the activities being executed by a user.

The timestamp field 206 indicates a time the activity was initiated or a time the activity is completed. In other examples, the timestamp includes a time the activity is initiated and a time the activity is completed. The resource field 210 indicates a user that executes the activity identified in the activity field 204. The age field 214 indicates the location the activity is performed in, and the age field 216 indicates the age of a resource executing the activity. In some examples, the event log 200 includes additional fields or less fields than what is shown in FIG. 2. In addition, in some examples, the event log 200 is not represented as a table as shown in FIG. 2, and instead, the event log 200 is a list of the information shown in FIG. 2 and stored in the storage 104 with tags that indicate the information that corresponds to a specific process-ID, timestamp, activity, and/or resource.

With reference back to FIG. 1, the batch processing engine 116 accesses the event log 200 from storage 104 to determine batches from the information provided in the event log 200. The batch processing engine 116 identifies a plurality of processes in the event log 200, with each process being represented by a process-ID in the process-ID field 202. The batch processing engine converts the plurality of processes in the event log 200 into a plurality of tuples, each of the plurality of tuples corresponding to a respective process-ID in the process-ID field 202. Each of the plurality of tuples includes a plurality of tuple fields that include a plurality of the fields, for example, fields 202-216 in the event log 200. In some examples, each of the plurality of tuples includes the process-ID field 202, the activity field 204, the timestamp field 206, and/or the resource field 212. The batch processing engine 116 partitions the plurality of tuples based on each of the fields provided in the event log. However, the following examples are directed to the batch processing engine 116 partitioning the plurality of tuples based only on the activity field 204.

In the following example, the batch processing engine 116 uses the plurality of tuples based on the activity field 204 to create a plurality of segments from the plurality of tuples, each of the plurality of segments defined by a minimum timestamp value and a maximum timestamp value, for example, if each are provided in the timestamp field 206. That is, a segment is characterized with a minimum and the maximum timestamp values of its tuples and a segment can be represented by the following equation, where t is a tuple and tₜᵢₘₑ represents the execution time of tuple t.

Sₘᵢₙ^{max}={t|max≥tₜᵢₘₑ≥min} Equation (1)

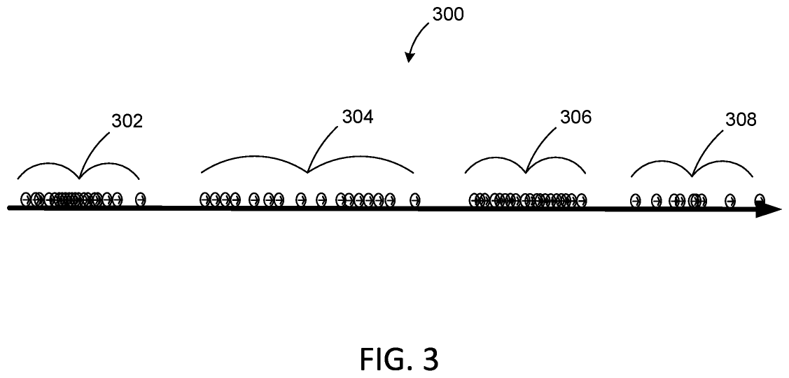

In the above example, segments do not have an intersection and a union of the segments is an input list of the partitioned plurality of tuples. Density-based clustering is used to place the plurality of tuples within a corresponding one of the plurality of segments based on the event timestamp field in the plurality of tuples and the minimum timestamp value and the maximum timestamp value in the partitioned plurality of tuples. For example, as shown in FIG. 3, the partitioned plurality of tuples are illustrated in a table 300 to be associated with or assigned to one of the segments 302, 304, 306, and 308 based on time.

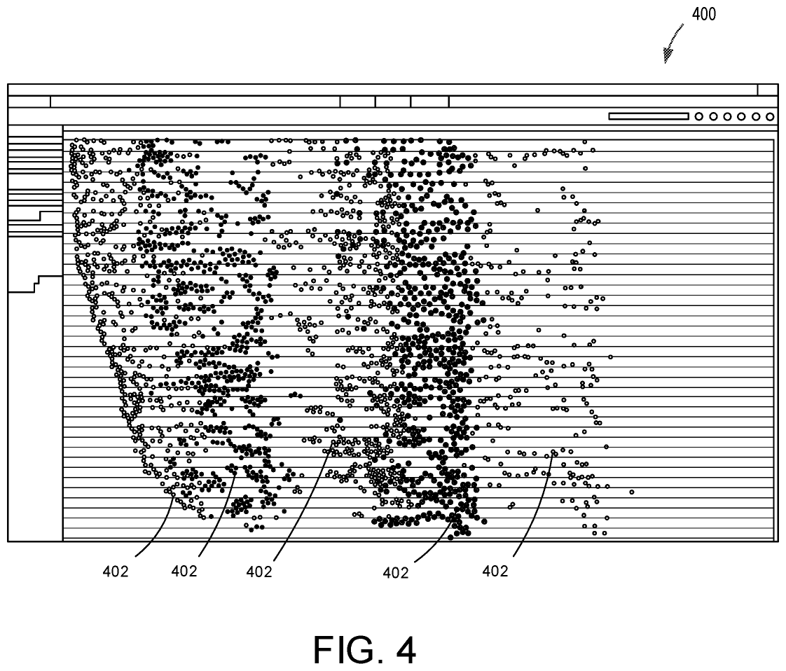

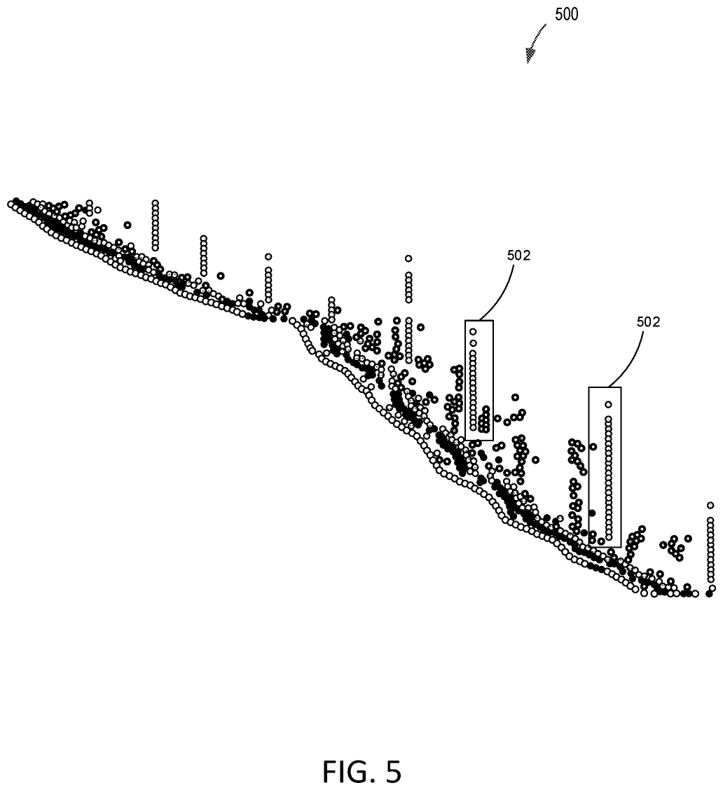

With reference now to FIG. 4, a two-dimensional dotted chart 400 illustrating different process instances in the event log 200 is shown. In the dotted chart 400, the X-axis represents time and the y-axis represent different process instances in the event log 200. For example, different events are represented as dots 402 in the dotted chart 400, and activities are represented as different colors or as different shades. In another example, the dots are colored differently based at least on their resources or the combination of their resources and activities. In some examples, the dotted chart 400 is interactive as the user can zoom in on the dotted chart 400 to visually see which group of activities are determined to be a batch. For example, with reference to FIG. 5, a zoomed in version of the dotted chart 400 is provided. As shown in FIG. 5, a first batch 502 and a second batch 504 are readily identifiable to a user based on a boundary encapsulating each of the first batch 502 and the second batch 504.

In some embodiments, the batch processing engine 116 also provides a user with some statistical information. For example, the batch processing engine 116 indicates that “User X executed 45 times activity Submit Document in 4 hours where the previous execution was 3 days before.” Moreover, the batch processing engine 116 can provide a summary for each of the detected batches. For example, a summary indicates that Sara is involved in 10 batches or that 70 percent of the detected batches are related to the activity “Submit Document”.

After detecting the segments 302-308, the batch processing engine 116 determines the most impactful, for example, with negative impact, number of the segments 302-308. In some examples, a segment is ranked based on one or more of the following characteristics: a number of tuples in a segment or |Sₘᵢₙ^{max}|, a length of the segment or max−min, a distance of the segment with a previous segment, a number of segments in a partition, and a number of tuples in the partition. In some example, each segment has a metric based on one or more of the characteristics and critical segments are determined to be batches. For example, the batch processing engine 116 identifies a segment as a batch when a ranking of the segment is above a batch ranking threshold. In some examples, the batch ranking threshold is defined by the administrator, the employer, or is automatically determined by the batch processing engine 116 based on all of the information in the event log 200.

In some examples, the batch processing engine 116 compares each detected batch with a set of policies that are defined by an administrator or employer. In one example, the set of policies include a rule and a threshold for each of the plurality of fields 202-216 and the comparing includes comparing each field of the batch to a respective rule and threshold. In some examples, when the batch processing engine 116 determines that a value in a field of the detected batch breaks a respective rule or exceeds a respective threshold in the set of policies, the batch processing engine 116 provides a recommendation to optimize the process represented by the detected batch. For example, the recommendation includes a recommendation to modify a value (e.g., manually modify or modify using different inputs resulting in a new value) in a field such that the value in the field does not break the respective rule or exceed the respective threshold. In another example, the batch processing engine compares each task in the detected batch to corresponding tasks in other detected batches comprising the same activity. The batch processing engine 116 determines that one or more tasks in the other detected batches are automated and based on the determining, provides a recommendation to automate the one or more tasks in the current detected batch. In another example, the batch processing engine 116 determines that one or more tasks in a current batch are not in the other detected batches. As such, the batch processing engine provides a recommendation to modify the batch by, for example, removing the one or more tasks from the activity of the current batch.

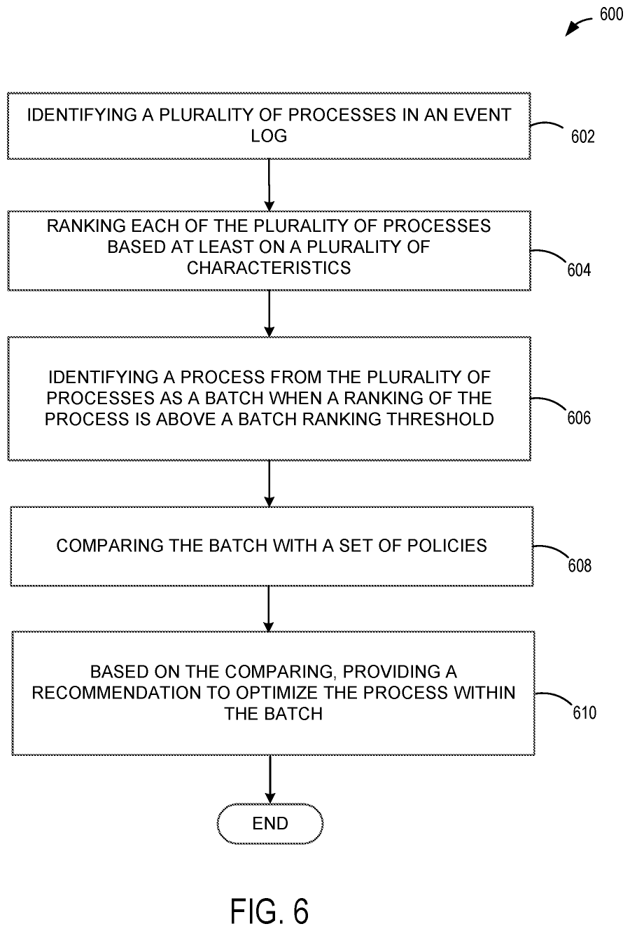

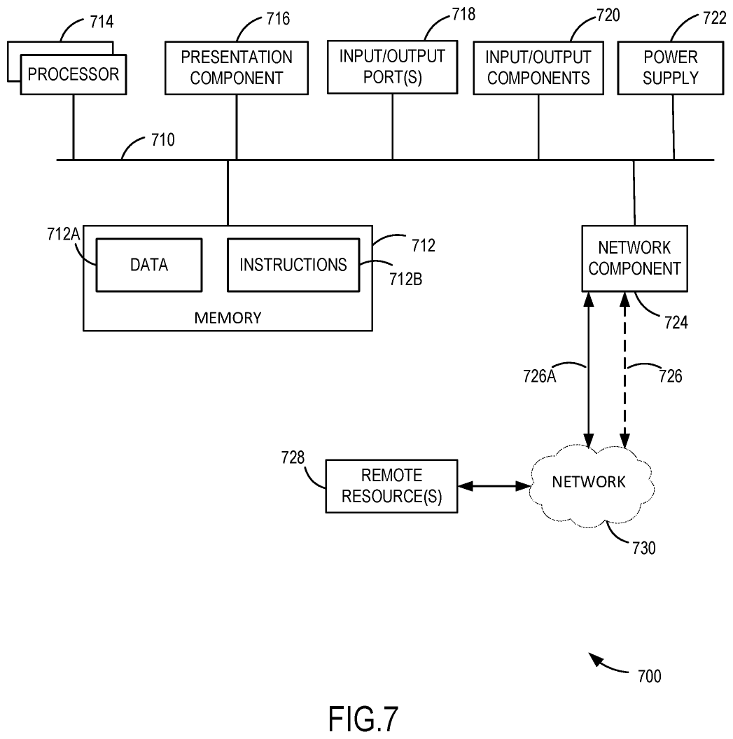

FIG. 6 shows a flowchart 600 illustrating exemplary operations that are performed by the batch processing system 100. In some examples, operations described for flowchart 600 are performed by computing device 700 of FIG. 7. Flowchart 600 commences at 602 when a plurality of processes in the event log 200 are identified. In some examples, the event log 200 is accessed to identify each process. In other examples, the event log 200 is not in a form of a table as shown in FIG. 2, and instead, the information within the event log 200 is stored in the storage 104, with the information of each of the fields 204-206 being associated with, for example, tagged, with a corresponding process-ID.

At 604, each of the plurality of processes are ranked based at least on a plurality of characteristics. In some examples, the plurality of processes in the event log 200 are converted into a plurality of tuples comprising a plurality of fields, such as an activity field, an event timestamp field, and a waiting time field. The plurality of tuples are partitioned based on one of the fields, for example, the activity field, and a plurality of segments are created from the plurality of tuples. In one example, each of the plurality of segments is defined by a minimum timestamp value and a maximum timestamp value. The plurality of tuples are placed within a corresponding one of the plurality of segments based on the event timestamp field in the plurality of tuples and the minimum timestamp value and the maximum timestamp value in the plurality of segments. Thereafter, each of the plurality of segments are ranked based at least on the plurality of characteristics, such as a number of tuples in a segment and a length of the segment.

At 606, a process from the plurality of processes is identified as a batch when a ranking of the process is above a batch ranking threshold. In some examples, the batch ranking threshold is set by a user, such as an administrator or an employer. At 608 the batch is compared with a set of policies, and at 610, a recommendation is provided to the user on how to optimize a process within the batch. In one example, each field of the batch is compared to a respective rule and threshold. When a value in a field is determined to break a respective rule or exceeds a respect threshold in the set of policies, a recommendation, the batch is identified as a candidate for optimization. In some examples, the recommendation includes a recommendation to modify the batch. That is, the recommendation includes a recommendation to utilize a different resource, for example, a less experienced user, a more experienced user, or a user with additional credentials. In some example, the recommendation also includes a recommendation to reduce a time to perform an activity or alter a start time and end time to the activity. For example, the start time currently identified in the batch is a start time that falls on a day in which access to other resources is limited and thus results in a delay. As such, the recommendation is to initiate the activity on a different day or time when resources are more readily available.

In another example, the batch is compared with other batches with one or more of the same fields, for example, the same activity listed in the activity field 204. In this example, the tasks that make up the activity are compared with other batches sharing the same activity. Based on the comparison, it is determined that one or more of the tasks used to complete the activity are automated in the other batches. As such, the recommendation is to automate one or more of these tasks as they are currently manually performed in the batch.

### Additional Examples

An example system for optimizing a batchable process comprises: a processor, and a computer-readable medium storing instructions that are operative upon execution by the processor to: identify a plurality of processes in an event log, rank the plurality of processes based at least on a plurality of characteristics, identify a process from the plurality of processes as a batch when a ranking of the process is above a batch ranking threshold, compare the batch with a set of policies, and based on the comparing, provide a recommendation to optimize the process within the batch.

An exemplary method for optimizing a batchable process comprises: identifying a plurality of processes in an event log, ranking the plurality of processes based at least on a plurality of characteristics, identifying a process from the plurality of processes as a batch when a ranking of the process is above a batch ranking threshold, comparing the batch with a set of policies, and based on the comparing, providing a recommendation.

An exemplary computer storage devices has computer-executable instructions stored thereon, which, on execution by a computer, cause the computer to perform operations comprising: identifying a plurality of processes in an event log, ranking the plurality of processes based at least on a plurality of characteristics, identifying a process from the plurality of processes as a batch when a ranking of the process is above a batch ranking threshold, comparing the batch with a set of policies, and based on the comparing, providing a recommendation to optimize the process within the batch.

Alternatively, or in addition to the other examples described herein, examples include any combination of the following:
identifying the plurality of processes comprises: accessing an event log comprising the plurality of processes, each of the plurality of processes comprising a process-ID, an activity, and a timestamp;
generating a plurality of tuples from the plurality of processes in the event log, wherein members of the plurality of tuples correspond to a respective process-IDs, and wherein members of the plurality of tuples comprise a plurality of fields, the plurality of fields comprising an activity field, an event timestamp field, and a waiting time field;
partitioning the plurality of tuples based on the activity field;
creating a plurality of segments from the plurality of tuples, wherein the plurality of segments are defined by a minimum timestamp value and a maximum timestamp value;
placing the plurality of tuples within a corresponding one of the plurality of segments based on the event timestamp field in the plurality of tuples and the minimum timestamp value and the maximum timestamp value in the plurality of segments;
ranking the plurality of segments based at least on the plurality of characteristics;
compiling the program for the target processor comprises placing an instruction from each set of instructions of the plurality of sets of instructions into a single VLIW instruction;
the set of policies comprising a rule and a threshold for each of the plurality of fields.
comparing each field of the batch to a respective rule and threshold;
determining that a value in a field of the batch breaks a respective rule or exceeds a respective threshold in the set of policies;
based on the determining, provide a recommendation to modify the value in the field such that the value in the field does not break the respective rule or exceed the respective threshold;
the recommendation comprises a recommendation to modify a value in a field such that the value in the field does not break the respective rule or exceed the respective threshold;
comparing the tasks in the batch to tasks in other batches comprising a same activity;
determining that certain tasks in the other batches are automated; and
based on the determining, providing a recommendation to automate tasks in the batch that correspond to the certain tasks.

While the aspects of the disclosure have been described in terms of various examples with their associated operations, a combination of operations from any number of different examples is also within scope of the aspects of the disclosure.

### Example Operating Environment

FIG. 7 is a block diagram of the computing device 700 (e.g., a computer storage device) for implementing aspects disclosed herein, and is designated generally as the computing device 700. In some examples, one or more of the computing devices 700 are provided for an on-premises computing solution. In some examples, one or more computing devices 700 are provided as a cloud computing solution. In some examples, a combination of on-premises and cloud computing solutions are used. The computing device 700 is but one example of a suitable computing environment and is not intended to suggest any limitation as to the scope of use or functionality of the examples disclosed herein, whether used singly or as part of a larger set.

Neither should the computing device 700 be interpreted as having any dependency or requirement relating to any one or combination of components/modules illustrated. Some examples disclosed herein are be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples can be practiced in distributed computing environments when tasks are performed by remote-processing devices that are linked through a communications network.

The computing device 700 includes a bus 710 that directly or indirectly couples the following devices: computer storage memory 712, one or more processors 714, one or more presentation components 716, input/output (I/O) ports 718, I/O components 720, a power supply 722, and a network component 724. While the computing device 700 is depicted as a seemingly single device, multiples of the computing device 700 work together and share the depicted device resources. For example, the memory 712 is distributed across multiple devices, and the processor(s) 714 are housed with different devices.

Bus 710 represents one or more busses (such as an address bus, data bus, or a combination thereof). Although the various blocks of FIG. 7 are shown with lines for the sake of clarity, in some examples, delineating various components is accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 7 and the references herein to a “computing device.” In some examples, the memory 712 takes the form of the computer storage media referenced below and operatively provide storage of computer-readable instructions, data structures, program modules and other data for the computing device 700. In some examples, the memory 712 stores one or more of an operating system, a universal application platform, or other program modules and program data. The memory 712 is thus able to store and access data 712a and instructions 712b that are executable by the processor(s) 714 and configured to carry out the various operations disclosed herein.

In some examples, the memory 712 includes computer storage media. The memory 712 includes any quantity of memory associated with or accessible by the computing device 700. In some examples, the memory 712 is internal to the computing device 700 (as shown in FIG. 7), external to the computing device 700 (not shown), or both (not shown). Additionally, or alternatively, the memory 712 is distributed across multiples of the computing devices 700, for example, in a virtualized environment in which instruction processing is carried out on multiples of the computing devices 700. For the purposes of this disclosure, “computer storage media,” “computer-storage memory,” “memory,” and “memory devices” are synonymous terms for the memory 712 (e.g., the computer-storage memory), and none of these terms include carrier waves or propagating signaling.

The processor(s) 714 includes any quantity of processing units that read data from various entities, such as the memory 712 or the I/O components 720. Specifically, the processor(s) 714 are programmed to execute computer-executable instructions for implementing aspects of the disclosure. The instructions are performed by the processor, by multiple processors within the computing device 700, or by a processor external to the computing device 700. In some examples, the processor(s) 714 are programmed to execute instructions such as those illustrated in the flow charts discussed below and depicted in the accompanying drawings. Moreover, in some examples, the processor(s) 714 represent an implementation of analog techniques to perform the operations described herein. For example, the operations are performed by an analog client computing device, for example, the computing device 700 and/or a digital client computing device, for example the computing device 700. The one or more presentation component(s) 716 present data indications to a user or other device. Exemplary presentation components include a display device, speaker, printing component, vibrating component, etc. In some examples, computer data is presented in a number of ways, such as visually in a graphical user interface (GUI), audibly through speakers, wirelessly between two or more of the computing device 700, across a wired connection, or in other ways. The I/O ports 718 allow the computing device 700 to be logically coupled to other devices including the I/O components 720, some of which is built in in some examples. Examples of the I/O components 720 include, for example but without limitation, a microphone, joystick, game pad, satellite dish, scanner, printer, wireless device, etc.

In some examples, the computing device 700 operates in a networked environment via the network component 724 using logical connections to one or more remote computers. In some examples, the network component 724 includes a network interface card and/or computer-executable instructions (e.g., a driver) for operating the network interface card. In some examples, communication between the computing device 700 and other devices occur using any protocol or mechanism over any wired or wireless connection. In some examples, network component 724 is operable to communicate data over public, private, or hybrid (public and private) using a transfer protocol, between devices wirelessly using short range communication technologies (e.g., near-field communication (NFC), BLUETOOTH branded communications, or the like), or a combination thereof. Network component 724 communicates over wireless communication link 726 and/or a wired communication link 726a to a remote resource 728 (e.g., a cloud resource) across network 730. Various different examples of the communication links 726 and 726a include a wireless connection, a wired connection, and/or a dedicated link, and in some examples, at least a portion is routed through the internet.

Although described in connection with an example of the computing device 700, examples of the disclosure are capable of implementation with numerous other general-purpose or special-purpose computing system environments, configurations, or devices. Examples of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. In some examples, such systems or devices accept input from the user in any way, including from input devices such as a keyboard or pointing device, via gesture input, proximity input (such as by hovering), and/or via voice input.

Examples of the disclosure are described in the general context of computer-executable instructions, such as program modules, executed by one or more computers or other devices in software, firmware, hardware, or a combination thereof. In some examples, the computer-executable instructions are organized into one or more computer-executable components or modules. Generally, program modules include, but are not limited to, routines, programs, objects, components, and data structures that perform particular tasks or implement particular abstract data types. In some examples, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and is performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for optimizing a batchable process, the system comprising:
a processor; and
a computer-readable medium storing instructions that are operative upon execution by the processor to:
identify a plurality of processes in an event log;
rank the plurality of processes based at least on a plurality of characteristics;
identify a process from the plurality of processes as a batch when a ranking of the process is above a batch ranking threshold;
compare the batch with a set of policies; and
based on the comparing, provide a recommendation to optimize the process within the batch.

2. The system of claim 1, wherein identifying the plurality of processes comprises: accessing an event log comprising the plurality of processes, the plurality of processes comprising a plurality of process-IDs, activities, and timestamps.

3. The system of claim 2, wherein ranking the plurality of processes comprises:
generating a plurality of tuples from the plurality of processes in the event log, wherein members of the plurality of tuples correspond to a respective process-IDs, and wherein members of the plurality of tuples comprise a plurality of fields, the plurality of fields comprising an activity field, an event timestamp field, and a waiting time field;
partitioning the plurality of tuples based on the activity field;
creating a plurality of segments from the plurality of tuples, wherein the plurality of segments are defined by a minimum timestamp value and a maximum timestamp value;
placing the plurality of tuples within a corresponding one of the plurality of segments based on the event timestamp field in the plurality of tuples and the minimum timestamp value and the maximum timestamp value in the plurality of segments; and
ranking the plurality of segments based at least on the plurality of characteristics.

4. The system of claim 3, wherein the plurality of characteristics comprises: a number of tuples in a segment and a length of the segment.

5. The system of claim 1, wherein the set of policies comprises a rule and a threshold for a plurality of fields of the batch, and wherein the comparing comprises:
comparing the plurality of fields of the batch to respective rules and thresholds;
determining that a value in a field of the plurality of fields breaks a respective rule or exceeds a respective threshold in the set of policies; and
based on the determining, provide a recommendation to modify the value in the field such that the value in the field does not break the respective rule or exceed the respective threshold.

6. The system of claim 5, wherein the recommendation comprises a recommendation to modify a value in a field such that the value in the field does not break the respective rule or exceed the respective threshold.

7. The system of claim 1, wherein the batch includes an activity comprising tasks, and wherein the comparing comprises:
comparing the tasks in the batch to tasks in other batches comprising a same activity;
determining that certain tasks in the other batches are automated; and
based on the determining, providing a recommendation to automate tasks in the batch that correspond to the certain tasks.

8. A method for optimizing a batchable process, the method comprising:
identifying a plurality of processes in an event log;
ranking the plurality of processes based at least on a plurality of characteristics;
identifying a process from the plurality of processes as a batch when a ranking of the process is above a batch ranking threshold;
comparing the batch with a set of policies; and
based on the comparing, providing a recommendation to optimize the process within the batch.

9. The method of claim 8, wherein identifying the plurality of processes comprises: accessing an event log comprising the plurality of processes, the plurality of processes comprising a plurality of process-IDs, activities, and timestamps.

10. The method of claim 9, wherein ranking the plurality of processes comprises:
generating a plurality of tuples from the plurality of processes in the event log, wherein members of the plurality of tuples correspond to a respective process-IDs, and wherein members of the plurality of tuples comprise a plurality of fields, the plurality of fields comprising an activity field, an event timestamp field, and a waiting time field;
partitioning the plurality of tuples based on the activity field;
creating a plurality of segments from the plurality of tuples, wherein the plurality of segments are defined by a minimum timestamp value and a maximum timestamp value;
placing the plurality of tuples within a corresponding one of the plurality of segments based on the event timestamp field in the plurality of tuples and the minimum timestamp value and the maximum timestamp value in the plurality of segments; and
ranking the plurality of segments based at least on the plurality of characteristics.

11. The method of claim 10, wherein the plurality of characteristics comprises: a number of tuples in a segment and a length of the segment.

12. The method of claim 8, wherein the set of policies comprises a rule and a threshold for a plurality of fields of the batch, and wherein the comparing comprises:
comparing the plurality of fields of the batch to respective rules and thresholds;
determining that a value in a field of the plurality of fields breaks a respective rule or exceeds a respective threshold in the set of policies; and
based on the determining, provide a recommendation to modify the value in the field such that the value in the field does not break the respective rule or exceed the respective threshold.

13. The method of claim 12, wherein the recommendation comprises a recommendation to modify the value in the field such that the value in the field does not break the respective rule or exceed the respective threshold.

14. The method of claim 8, wherein the batch includes an activity comprising tasks, and wherein the comparing comprises:
comparing the tasks in the batch to tasks in other batches comprising a same activity;
determining that certain tasks in the other batches are automated; and
based on the determining, providing a recommendation to automate tasks in the batch that correspond to the certain tasks.

15. A computer storage device having computer-executable instructions stored thereon, which, on execution by a computer, cause the computer to perform operations comprising:
identifying a plurality of processes in an event log;
ranking the plurality of processes based at least on a plurality of characteristics;
identifying a process from the plurality of processes as a batch when a ranking of the process is above a batch ranking threshold;
comparing the batch with a set of policies; and
based on the comparing, providing a recommendation to optimize the process within the batch.

16. The computer storage device of claim 15, wherein identifying the plurality of processes comprises: accessing an event log comprising the plurality of processes, the plurality of processes comprising a plurality of process-IDs, activities, and timestamps.

17. The computer storage device of claim 16, wherein ranking the plurality of processes comprises:
generating a plurality of tuples from the plurality of processes in the event log, wherein members of the plurality of tuples correspond to a respective process-IDs, and wherein members of the plurality of tuples comprise a plurality of fields, the plurality of fields comprising an activity field, an event timestamp field, and a waiting time field;
partitioning the plurality of tuples based on the activity field;
creating a plurality of segments from the plurality of tuples, wherein the plurality of segments are defined by a minimum timestamp value and a maximum timestamp value;
placing the plurality of tuples within a corresponding one of the plurality of segments based on the event timestamp field in the plurality of tuples and the minimum timestamp value and the maximum timestamp value in the plurality of segments; and
ranking the plurality of segments based at least on the plurality of characteristics.

18. The computer storage device of claim 15, wherein the set of policies comprises a rule and a threshold for a plurality of fields of the batch, and wherein the comparing comprises:
comparing the plurality of fields of the batch to respective rules and thresholds;
determining that a value in a field of the plurality of fields breaks a respective rule or exceeds a respective threshold in the set of policies; and
based on the determining, provide a recommendation to modify the value in the field such that the value in the field does not break the respective rule or exceed the respective threshold

19. The computer storage device of claim 18, wherein the recommendation comprises a recommendation to modify a value in a field such that the value in the field does not break the respective rule or exceed the respective threshold.

20. The computer storage device of claim 15, wherein the batch includes an activity comprising tasks, and wherein the comparing comprises:
comparing the tasks in the batch to tasks in other batches comprising a same activity;
determining that certain tasks in the other batches are automated; and
based on the determining, providing a recommendation to automate tasks in the batch that correspond to the certain tasks.
